(19) United States
(12) Patent Application Publication
(10) Pub. No.: US 2026/0099667 A1
(43) Pub. Date: Apr. 9, 2026

(54) RECOGNIZING TABLES IN UNSTRUCTURED TEXT

(71) Applicant: Microsoft Technology Licensing, LLC, Redmond, WA (US)

(72) Inventors: Mukul SINGH, Seattle, WA (US); Sumit GULWANI, Sammamish, WA (US); Vu Minh LE, Redmond, WA (US); Gust Ben Anneloes VERBRUGGEN, Keerbergen (BE)

(73) Assignee: Microsoft Technology Licensing, LLC, Redmond, WA (US)

(21) Appl. No.: 18/906,354

(22) Filed: Oct. 4, 2024

(51) Int. Cl. G06F 40/177; G06F 16/23; G06F 16/34; G06F 40/258

(52) U.S. Cl. CPC G06F 40/177; G06F 16/2365; G06F 16/34; G06F 40/258

(57) ABSTRACT

A data processing system includes a processor; and a memory in communication with the processor. The memory contains executable instructions that, when executed by the processor alone or in combination with other processors, cause the data processing system to perform functions of: detecting column headers within an unstructured text using a trained classifier; prompting a Large Language Model (LLM) to produce a table sketch based on detected headers and the unstructured text; generating candidate rows for lines of the unstructured text not included in the table sketch using a symbolic system; ranking the candidate rows based on consistency with a consistency ranker; and assembling a final table based on the unstructured text by adding candidate rows based on rank to the table sketch.

### BACKGROUND

Documents may be stored and presented in a wide variety of forms and formats. For example, a document can be a printed hardcopy or an electronic file displayed on a display device. Traditionally, documents were primarily hardcopy, meaning they were physical papers, books, or files that needed to be manually stored, handled, and distributed. With the advent of digital technology, electronic documents have become increasingly prevalent, offering convenience, flexibility, and case of access.

In electronic form, documents can exist in various formats, each serving different purposes and offering distinct advantages. One of the simplest and most widely used formats is plain text, which consists of unformatted, readable text without any special styling or layout. This format is lightweight and versatile, making it ideal for quick notes, programming scripts, or data files that don't require complex formatting.

A more structured and commonly used format is Portable Document Format (PDF). PDFs are designed to preserve the layout and formatting of a document regardless of the software or device used to view it. This makes PDFs ideal for sharing documents that need to be printed or viewed consistently across different platforms, such as contracts, reports, or forms.

Beyond text-based formats, electronic documents can also include spreadsheets, presentations, and even multimedia files such as audio, video, and images. Each format is tailored to specific types of content, allowing for the organization, presentation, and manipulation of data in ways that best suit the document's purpose.

### SUMMARY

In one general aspect, the following description presents a data processing system includes a processor; and a memory in communication with the processor. The memory contains executable instructions that, when executed by the processor alone or in combination with other processors, cause the data processing system to perform functions of: detecting column headers within an unstructured text using a trained classifier; prompting a Large Language Model (LLM) to produce a table sketch based on detected headers and the unstructured text; generating candidate rows for lines of the unstructured text not included in the table sketch using a symbolic system; ranking the candidate rows based on consistency with a consistency ranker; and assembling a final table based on the unstructured text by adding candidate rows based on rank to the table sketch.

In another general aspect, the following description presents a method of generating a table from unstructured text, the method including: identifying headers for the table within the unstructured text using a classifier model including an embedding-based classifier model that is trained to recognize individual headers within the unstructured text; generating a table sketch from which a final table is constructed, the table sketch generated by prompting an LLM with identified headers identified by the classifier model and a portion of the unstructured text, the table sketch comprising identified headers and a number of table rows; and adding additional table rows to the table sketch using a consistency ranker that is operating on the unstructured text to generate the final table that captures capturing data from the unstructured text in table form.

In another general aspect, the following description presents a method of generating a table from unstructured text, the method including: detecting header rows from the unstructured text using a custom model; generating, with a Large Language Model, (1) example rows and (2) auxiliary information comprising at least one of a row count, a column count, a header count, and a data pattern for a final table; validating output of the LLM against the auxiliary information; constructing the final table using a symbolic system operating on the example rows and auxiliary information to guide construction, wherein the symbolic system comprises a model that relies on row and column level consistency measures based on (1) semantic features including embedding similarity and (2) symbolic features including regexes and types; and iteratively refining the constructed final table by identifying a worst scoring row as to the consistency measures and adjusting that worst scoring row until either the consistency scores are above a threshold or a maximum number of iterations is reached.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this specification may be implemented.

FIG. 2 depicts an example of the input data for the system of FIG. 1.

FIGS. 3-5 depicts additional details in an example of the system of FIG. 1

FIGS. 6A and 6B depict flowcharts of methods in which aspects of this specification may be implemented.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

As noted above, electronic documents can include spreadsheets, presentations, and even multimedia files such as audio, video, and images. Frequently, tables are used in documents to present information in the form of an array. As used herein and in the appended claims, a table is a data structure that includes cells arranged in rows and columns. Each cell contains data. One or more rows may constitute a header defining the type of data listed in the corresponding column.

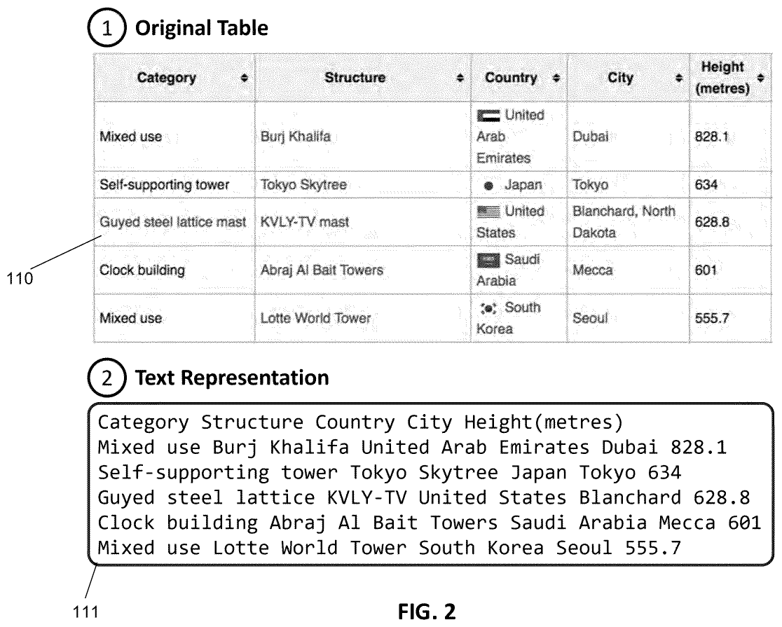

Depending on the type of document that includes a table, the table itself may be an embedded image or graphic or may be data with specific tabular metadata to support the correct organization and presentation of the data as a table when displayed or printed. On occasion, a user may want to copy a table from a document or application for use elsewhere or to convert text data into a table.

Where a table is being copied from one presentation to another, the table is often copied and moved as free-form text. For example, when copying a table from a rendered document like a PDF or website, the user cuts and pastes the text in the table without being able to readily retain the organized structure of the table. This is explained in more detail below with reference to FIG. 2. Users are then dependent on manual efforts or programming abilities to parse this free-form text back into a structured table.

In any context, converting text to a table poses several challenges concerning the semantics and consistency of the table, as well as its scale. Thus, copying tables from documents and applications, such as PDF documents, web pages or images, without proper tabular support, remains a challenge. This is a technical problem confronting users that need to copy or reuse a table from one document or location to another.

To solve this technical problem, the following specification presents a novel neurosymbolic system for reconstructing tables without structural information. Specifically, this is a system that leverages large language models for table construction from free-form text.

At a high level, the described approach includes detecting headers, generating an initial table sketch using an LLM, and using that sketch as a guiding representation during an enumerate-and-test strategy that evaluates syntactic and semantic table structures. Unlike previous methods, which primarily rely on syntactic cues, the following approach uses the semantic knowledge of the language model to ensure that the reconstructed tables are both accurate and natural.

In more detail, the described system leverages an LLM to detect headers and to build a table sketch from a small subset of the data. Through multi-step reasoning, the language model ensures consistent cell boundaries over a natural granularity. Given this table sketch, the described system then explores and ranks potential cell boundaries for all the remaining rows. This ranker combines both syntactic and semantic information (based on cell value embeddings) to evaluate consistency of cells across the entire columns, and alignment of rows to the table sketch. In sum, this technical solution leverages the semantic knowledge of LLMs combined with the speed of a generate-and-rank strategy to accurately and quickly convert text to tables, including large tables.

This technical solution has been shown to outperform traditional techniques in both accuracy and scalability, handling large tables with over 100,000 rows. Specifically, an advantage of this technical solution is an increase in reconstruction accuracy of 5.8-11.3% over both neural and symbolic baseline systems. The described technical solution and system use language models as components to guide symbolic table construction rather than using them directly to generate tables as done previously. The system also uses the language model generation for guiding the symbolic construction system that determines breaks in lines of text. The system generates neural and symbolic consistency metrics for rows and columns that allow the system to score candidate tables. An algorithm is used to search over the computed scores to find the optimal candidate. The system automatically checks consistency between the language model output and the candidate lines for the tables through matching specific constraints.

By way of background, the detection of tables from various formats has been extensively studied, particularly in the context of images, PDF, and web data. We consider three scenarios.

Text to table. Generating tables from textual descriptions and online sources is another active research area. This involves transforming unstructured text into structured tabular formats. Techniques in this domain focus on understanding natural language descriptions and generating corresponding tables. Previous methods have employed natural language processing (NLP) and template-based approaches to map textual content to table structures. However, these methods have the technical problem of often relying on predefined templates and struggle with diverse and unstructured text inputs.

Web to table. The detection of tables from web pages leverages the HyperText Marckup Language (HTML) structure and Cascading Style Sheets (CSS) styles to identify and extract tables directly from the source. Early approaches used rule-based systems to parse HTML tags, while more recent methods employ dedicated models to enhance accuracy and generalization.

Image to table. Early work focused on extracting tables from scanned images using computer vision techniques. These approaches typically involve detecting table boundaries and cell divisions using edge detection and contour analysis or (convolutional) neural networks to improve the accuracy and robustness of table detection from images. Extracting tables from Optical Character Recognition (OCR) text and PDF documents presents unique challenges due to the lack of explicit structural information. Some attempts in this area employ heuristic-based approaches to detect table structures by analyzing spatial relationships between text blocks. More recent techniques utilize neural models to classify text blocks and infer table structures. These methods have a technical problem of often struggling with complex tables that lack clear boundaries or contain nested structures.

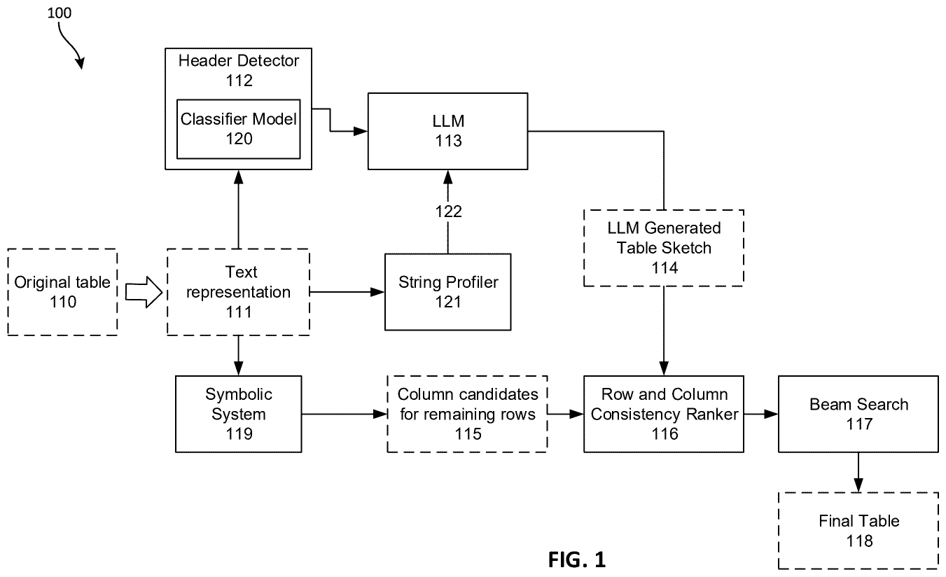

FIG. 1 illustrates an example of a system implementing the technical solution described herein. FIG. 2 illustrates an example of input to the system of FIG. 1. As shown in FIG. 2, the user wants to copy an original table (110) for use in another location or document. In this example, the table may come from a PDF document or website and lists tall structures around the world. A first column lists the category of the structure. The second column lists the name of the structure, followed by columns for the country and city where the structure is located and, lastly, the height of the structure in meters.

FIG. 2 also shows a text representation 111 of the table, also referred to herein as unstructured text. In the text representation 111, all the text from the original table is copied without retaining the cell structure of the table.

In the following approach, let

$$T = {[ {t}_{i}^{j} ]}_{i = 1 \to n}^{j = 1 \to m}$$

be a table with n rows and m columns. We write Tᵢ and T^{j} to denote row i and column j, respectively. The header

$$H = {[ {h}_{i}^{j} ]}_{i = 1 \to n}^{j = 1 \to k}$$

of a table are special cells that define the semantic structure of the table by assigning one or more names Hᵢ to each column i. A text-form table R is a deconstructed representation of a table T obtained by concatenating the values in each row (including headers) with a single space character to obtain m+k text rows Rᵢ. The system of FIG. 1 handles the task of converting a text-form table R to a structured table T without loss of information, and where each header Hᵢ correctly describes the data in its column.

Referring now to FIG. 1, the original table 110 is the initial input from which the text representation 111 is produced. Data from the text representation is input to a header detector 112. The header detector 112 includes an embedding-based classifier model 120 that is trained to determine if a row Rᵢ is header or not.

An embedding-based classifier model is a machine learning approach that leverages embedded representations of data for classification tasks. Embeddings are dense, low-dimensional vectors that capture the semantic meaning and contextual relationships within the data, whether text, images, or other types. For instance, in natural language processing, words or sentences are converted into numerical vectors that reflect their meanings and relationships to other words or sentences. These embedding vectors are then used as inputs for a classification algorithm, which is trained to assign labels or categories to the inputs based on patterns detected in the embeddings. This approach offers several benefits, including the ability to capture complex relationships in data, reducing dimensionality, and enabling transfer learning, where pre-trained embeddings can be applied across different tasks. Embedding-based classifiers are widely used in applications such as sentiment analysis, topic classification, image recognition, and recommendation systems, where they enhance the model's ability to interpret and classify complex data accurately.

The input to the header detector 112 is the embedding of the cells in the row. The header detector 112, based on its training, outputs a proposed set of headers that tries to match the headers of the original table 110. These proposed headers as well as a sample of lines from the text representation 111 are input to an LLM 113

An LLM is an advanced type of artificial intelligence designed to ingest, generate, and interact with human language. Trained on vast amounts of text data, an LLM can perform a variety of language-related tasks such as answering questions, translating languages, summarizing text, writing essays, and even engaging in conversations. It does this by generating text based on patterns used during training, making it a powerful tool for NLP applications.

In this system, the LLM is prompted with a request to produce a proposed table, referred to as a table sketch, from the proposed headers and sample of lines 122 from the text representation 111. Using its training, the LLM then generates a table sketch, which is intended to be much shorter than the original table 110, but which has the same or nearly the same headers, columns and initial rows of data.

In a specific example, the system can leverage a single LLM prompt to generate initial table sketch Ta. To generate the sample of lines 122, a string profiler 121 is used to determine a pattern for each row and uses these patterns to sample the five most diverse rows R_{d}.

A string profiler is a tool used in programming and data analysis to examine and analyze strings within a dataset. It provides detailed insights into the characteristics of the strings, such as their length, format, frequency, and the presence of specific patterns or anomalies. By profiling strings, one can identify inconsistencies, such as unexpected characters or irregular formats, which could indicate errors or the need for data cleaning. String profilers are particularly useful in preprocessing steps where parsing the structure and content of textual data is crucial for ensuring the quality and accuracy of subsequent analyses or machine learning models. They help in making informed decisions about data transformation and validation, ultimately improving the reliability of the data used in various applications.

The header rows and these five rows sampled by the string profiler 121 are used as inputs to the LLM 113. The LLM 113 is prompted to use all these inputs to produce the table sketch 114.

With regard to prompting the LLM, a program-of-thought or three-step reasoning prompt is used to instruct the LLM to describe the number of rows and columns, the headers, and the table sketch. A program-of-thought prompt and a three-step reasoning prompt both aim to guide an LLM through structured processing, but do so in slightly different ways. A program-of-thought prompt is designed to mimic a step-by-step process akin to how a human might write a program or algorithm to solve a problem. It directs the LLM to follow a logical sequence of steps, each building on the previous one, to arrive at a solution. This method is particularly useful when the task requires complex reasoning, multiple stages of processing, or when there are clear conditional paths to follow, much like a flowchart in programming.

The three-step reasoning prompt is a specific, simplified version of this idea. It breaks down the reasoning process into three distinct phases: understanding the problem, developing a plan, and executing that plan to reach a conclusion. While a program-of-thought prompt may involve more intricate or conditional steps and could be used for more complex or layered tasks, the three-step reasoning prompt provides a straightforward framework that guides the LLM through a logical process in a clear and linear manner.

In this specific example, the LLM is instructed to generate a pandas DataFrame using comments and assertions to guide its processing. When an LLM is instructed to generate a pandas DataFrame using comments and assertions, the LLM is prompted to approach the task much like a human programmer would, by not only writing the code but also documenting a reasoning process within the code itself. Comments are used to explain the purpose and logic behind each step, providing clarity on why certain operations are performed or why specific functions are chosen. Assertions serve as checkpoints within the code, verifying that certain conditions hold true, such as ensuring the DataFrame has the correct structure or that the data meets expected criteria. The system 100 uses the LLM's descriptions or answers to these reasoning steps to validate the table sketch 114. For example, the number of rows, columns and the header are all expected to align. The system may iterate five completions from the LLM and select the first one that satisfies the validation as the table sketch 114.

The table sketch 114 and the remaining lines or rows 115 of the text representation 111 are input to a row and column consistency ranker 116. Prior to this consistency analysis, a symbolic system is used to generate the potential breaks between future table cells in each row of the text representation 111. Specifically, for each row Rᵢ∈R\R_{d}, the ranker 116 will enumerate candidate rows

$${T}_{i}^{′}$$

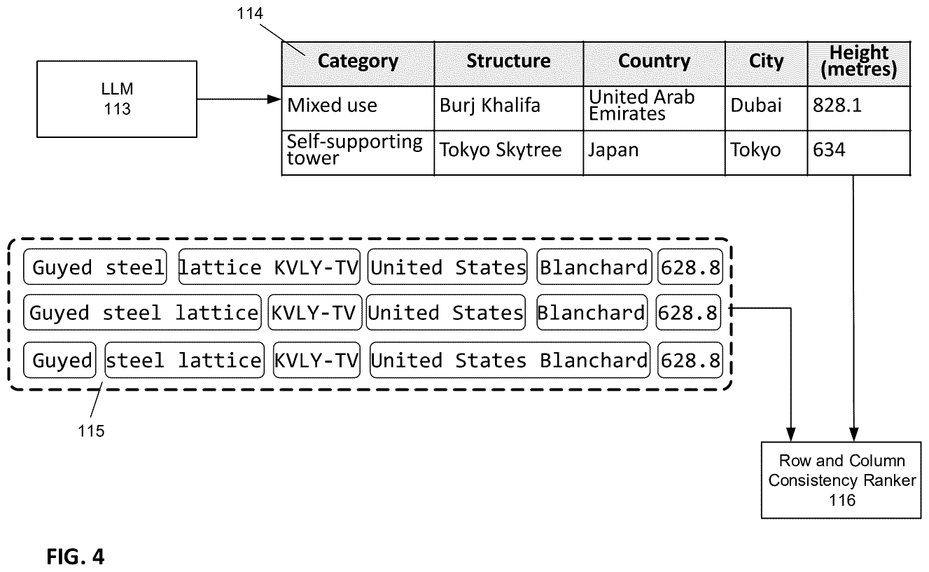

by inserting m-1 delimiters. An example is shown in FIG. 4. The ranker 116 uses four heuristics to insert delimiters: (1) analyzing delimiters the LLM assumed to generate T_{d} from R_{d}, (2) non-alphanumeric characters, (3) letter to number change, and (4) case change.

Working with the delimited options for each row, the ranker 116 then computes consistency

$$δ ( {T}_{i}^{′} , T )$$

of a new row

$${T}_{i}^{′}$$

with respect to a current table T, e.g., the table sketch 114 by combining one symbolic and two neural metrics. The symbolic metric involves recognizing a pattern over columns and computing a weighted (by pattern frequency) pattern edit distance deviation over the column. The neural metrics compute the average embedding similarity within each column, as well as over whole rows. These three metrics are aggregated as a linear combination with learned weights.

Starting from the table sketch 114 T_{d} and the heuristic, for each row Tᵢ, the ranker 116 greedily selects the candidate

$${T}_{i}^{′}$$

that maximizes the consistency

$$δ ( {T}_{i}^{′} , {T}_{d} ⋃ {T}_{< i}^{′} )$$

over T_{d} and the selected candidates for all previous rows. Starting from table sketch 114, the system picks the row with the lowest consistency and performs a beam search 117 over alternative candidates for each row until the consistency does not increase for a few iterations (local maximum) or a maximum number of iterations have been reached (e.g., 100).

A beam search 117 is a search algorithm used primarily in natural language processing and machine translation to generate sequences of words or tokens, such as sentences, by exploring multiple possible outcomes simultaneously. Unlike a simple greedy search that selects the most probable next step at each point, beam search maintains a fixed number of the most promising partial solutions at each step, known as the “beam width.” As the algorithm progresses, it evaluates and expands these partial solutions by considering the next set of possible tokens, ultimately selecting the sequence with the highest overall probability. This approach allows beam search to balance exploration and exploitation, generating more accurate and coherent sequences by avoiding the pitfalls of locally optimal but globally suboptimal choices. Beam search is widely used because it effectively navigates the vast space of possible sequences while managing computational complexity.

As shown in FIG. 1, this beam search allows the system 100 to construct or assemble the final table 118. The final table 118 is intended to approximate the original table 110 as closely as possible.

To train the header detector 112 and neural or consistency ranker 116, a Comma Separate Value (CSV) dataset. For example, this dataset could contain on the order of 100K noisy CSV files that are parses into 95K clean CSV files. This dataset is the augmented by shuffling columns. To train the ranker 116, candidate row enumeration is used including and sampling one wrong candidate (− example) per row (+ example).

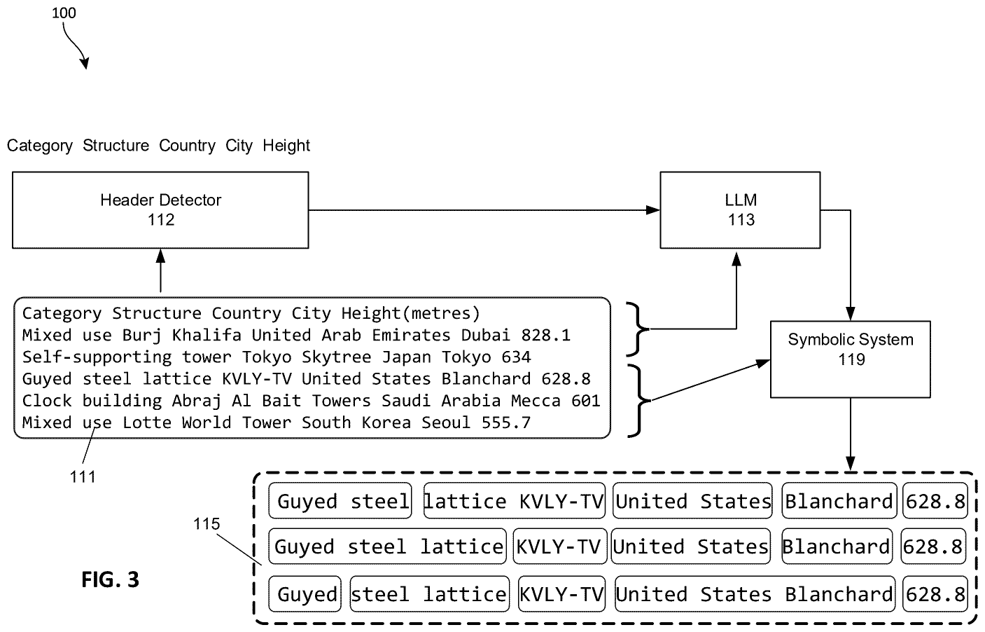

FIGS. 3-5 depicts additional details in an example of the system of FIG. 1. In the example of FIG. 3, the text representation 111 of the table is the same as in the example of FIG. 2. In this example, the first line of the text representation 111 is sent to the header detector 112 to detect the headers of the table. The detected headers are sent by the header detector 112 to the LLM 113. The LLM 113 also receives a sample of lines from the text representation. As described above, this may be five lines sampled based on being the most diverse lines or rows.

As described elsewhere, the LLM 113 will produce a table sketch as well as auxiliary information about the table. This information is provided by the LLM 113 to a symbolic system 119 that also receives the rest of the text representation after the sampled lines have been provided to the LLM 113.

The symbolic system 119 uses the output of the LLM 113, particularly the auxiliary information about the table. In the symbolic system 119, each of the remaining lines is parsed and divided in multiple different examples with different break points. As described above, for each row Rᵢ∈R\R_{d}, the system will generate a number of candidate rows

$${T}_{i}^{′}$$

by inserting m-1 delimiters. As shown in FIG. 3, a line includes the words “Guyed,” “steel,” “lattice,” “KVLY-TV,” “United,” “States,” “Blanchard,” and “628.8.” In FIG. 3, three different examples are shown of these words of this line being placed in different groupings in an attempt to identify the value for each column in the line. As described above, the system may use four heuristics to insert delimiters: (1) analyzing delimiters the LLM assumed to generate T_{d} from R_{d}, (2) non-alphanumeric characters, (3) letter to number change, and (4) case change.

Turning to FIG. 4, the LLM 113 outputs a table sketch 114 based on the headers identified by the header detector 112 and the sampled lines from the text representation 111. The consistency ranker 116 receives the table sketch 114 and builds on the table sketch 114 using the differently delimited versions 115 of the remaining lines of the text representation. Specifically, the ranker 116 computes consistency

$$δ ( {T}_{i}^{′} , T )$$

of a new row

$${T}_{i}^{′}$$

with respect to the table sketch 114 by combining one symbolic and two neural metrics. The symbolic metric involves recognizing a pattern over columns and computing a weighted (by pattern frequency) pattern edit distance deviation over the column. The neural metrics compute the average embedding similarity within each column, as well as over whole rows. These three metrics are aggregated as a linear combination with learned weights. Consequently, the consistency ranker 116 selects the most consistent match from among the differently delimited versions of the next row to be added to the table sketch 114. This is repeated for each line of data from the text representation 111.

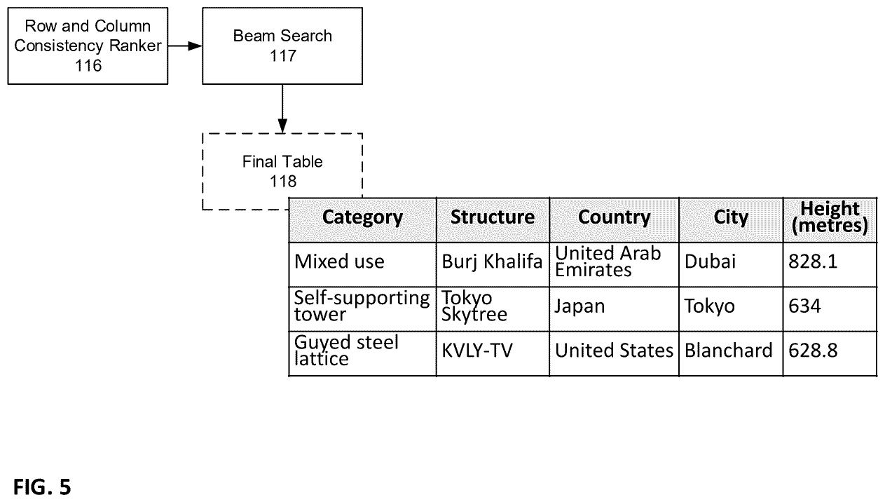

Turning to FIG. 5, the consistency ranker 116 makes use of a beam search 117. Specifically, starting from table sketch 114, the system picks the candidate row with the lowest consistency, and performs a beam search 117 over alternative candidates for each row until the consistency does not increase for a few iterations (local maximum) or a maximum number of iterations have been reached (e.g., 100). In this way, the ranker 116 and beam search 117 build the final table 118 by adding to the table sketch. The final table 118 should match or closely approximate the original table from which the text representation 111 was taken.

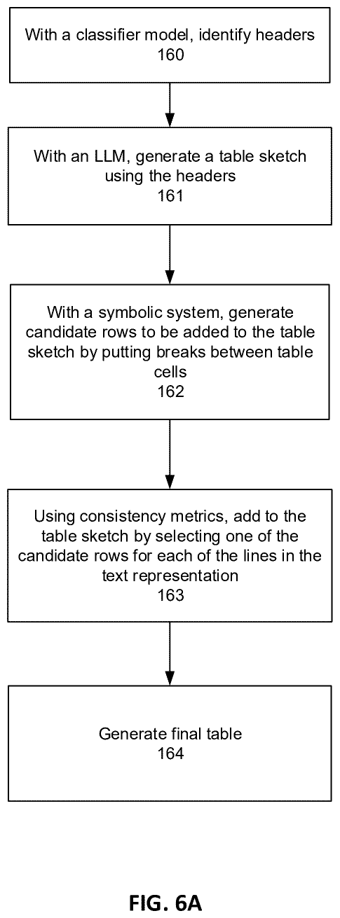

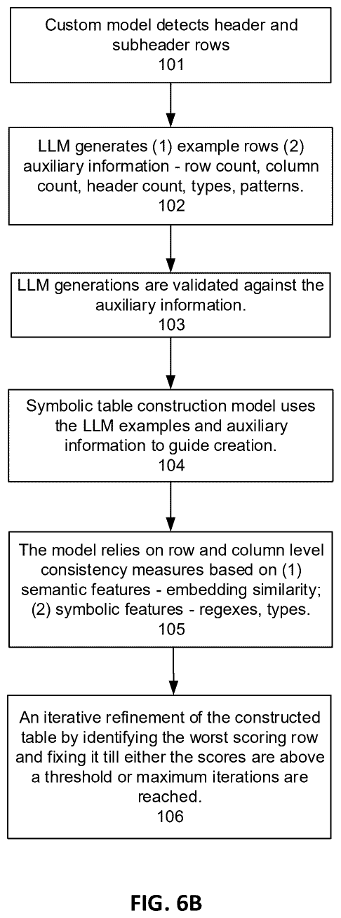

FIG. 6A depicts a flowchart of a method in which aspects of this specification may be implemented. These method steps, and those of FIG. 6B, can be performed automatically by the system without user intervention. As shown in FIG. 6A, and consistent with the description of the system above, the method begins with a text representation that is to be converted into a table. First, with a classifier model, headers are identified 160 from the text representation. Then, an LLM is used to generate 161 a table sketch and other information. The LLM uses the identified headers and sampled lines from the text representation. In previous work, the LLM has been used to generate an entire table from the text representation. However, this approach is prone to hallucination by the LLM and not nearly as effective as using the LLM selectively to produce only a table sketch from which the final table is assembled.

Next, with a symbolic system, as described herein, the remaining lines of the text representation are divided or delimited with breaks between words or phrases for individual cells of the table being produced. Multiple candidates with breaks in different places are generated 162 for each line in the text representation. Lastly, using consistency metrics, lines are added to the table sketch by selecting 163 one of the candidate rows corresponding to each of the lines of the text representation. This generates 164 the final table.

FIG. 6B depicts a flowchart of a method in which aspects of this specification may be implemented. This example may refer to and be implemented by the system of FIG. 1. As shown in FIG. 6B, a custom model detects 101 header and sub-header rows from within the text representation.

An LLM then generates 102 both (1) example rows and (2) auxiliary information such as row count, column count, header count, types and patterns. This may be iterated multiple times to produce multiple LLM generations with both example rows and auxiliary information. Then, the LLM generations are validated 103 against the respective auxiliary information.

Next, a symbolic table construction model uses 104 the LLM examples and auxiliary information guide table creation. The model relies 105 on row and column level consistency measures based on (1) semantic features-embedding similarity; (2) symbolic features-regexes, types. Lastly, an iterative refinement of the constructed table is performed 106 by identifying the worst scoring row and fixing it till either the scores are above a threshold or maximum iterations are reached.

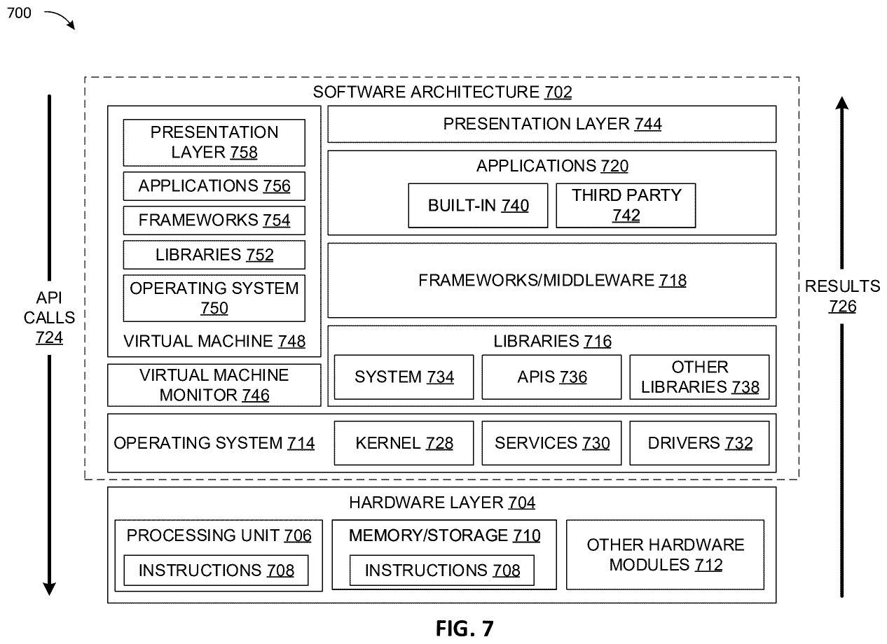

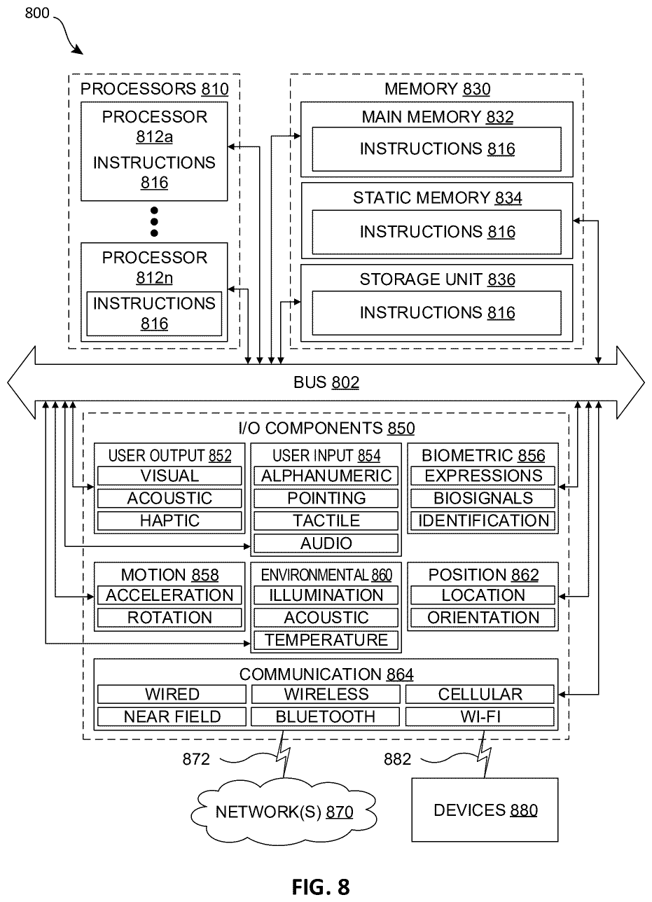

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor alone or in combination with other processors, cause the data processing system to perform functions of:
detecting column headers within an unstructured text using a trained classifier;
prompting a Large Language Model (LLM) to produce a table sketch based on detected headers and the unstructured text;
generating, via a symbolic system, candidate rows for lines of the unstructured text not included in the table sketch;
ranking, via a consistency ranker, the candidate rows based on consistency; and
assembling a final table based on the unstructured text by adding candidate rows based on rank to the table sketch.

2. The data processing system of claim 1, the classifier model being an embedding-based classifier model trained to identify individual headers from within the unstructured text.

3. The data processing system of claim 1, further comprising using a beam search in assembling the final table.

4. The data processing system of claim 1, further comprising a symbolic system to generate the candidate rows by placing breaks at different locations in lines from the unstructured text.

5. The data processing system of claim 4, further comprising a consistency ranker to operate with the symbolic system, the consistency ranker to select individual candidate rows from output of the symbolic system for inclusion in the final table based on consistency with the table sketch.

6. The data processing system of claim 4, wherein the LLM generates auxiliary information about the final table in addition to the table sketch, the symbolic system configured to use the auxiliary information to place breaks in lines from the unstructured text.

7. The data processing system of claim 6, wherein a prompt for the LLM comprises program-of-thought prompt, the auxiliary information resulting from execution of the program-of-thought prompt.

8. The data processing system of claim 1, wherein prompting the LLM further comprising providing a sample of lines from the unstructured text to the LLM for use in generating the table sketch.

9. The data processing system of claim 8, wherein the sample of lines comprises a number of most diverse rows of the unstructured text.

10. The data processing system of claim 8, further comprising a string profiler to select lines for the sample of lines from the unstructured text.

11. A method of generating a table from unstructured text, the method comprising:
identifying headers for the table within the unstructured text using a classifier model including an embedding-based classifier model trained to recognize individual headers within the unstructured text;
generating a table sketch from which a final table is constructed, the table sketch generated by prompting a Large Language Model (LLM) with the headers identified by the classifier model and a portion of the unstructured text, the table sketch including identified headers and a number of table rows; and
adding additional table rows to the table sketch using a consistency ranker that is operating on the unstructured text to generate the final table that captures data from the unstructured text in table form.

12. The method of claim 11, further comprising:
generating candidate table rows with a symbolic system;
selecting among the candidate table rows based on consistency with the table sketch to provide the additional table rows to be added to the table sketch.

13. The method of claim 12, wherein the symbolic system creates the candidate table rows by placing breaks at different locations in lines from the unstructured text.

14. The method of claim 13, wherein the symbolic system places the breaks based on output from the LLM describing the final table.

15. The method of claim 14, wherein a prompt for the LLM comprises program-of-thought prompt, and execution of the program-of-thought prompt provides the output describing the final table that is used by the symbolic system.

16. The method of claim 11, further comprising conducting a beam search when adding the additional table rows to the table sketch.

17. The method of claim 11, wherein prompting the LLM further comprising providing a sample of lines from the unstructured text to the LLM for use in generating the table sketch.

18. The method of claim 17, wherein the sample of lines comprises a number of most diverse rows of the unstructured text.

19. The method of claim 17, further comprising using a string profiler to select lines for the sample of lines from the unstructured text.

20. A method of generating a table from unstructured text, the method comprising:
detecting header rows from the unstructured text using a custom model;
generating, with a Large Language Model (LLM), (1) example rows and (2) auxiliary information comprising at least one of a row count, a column count, a header count, and a data pattern for a final table;
constructing the final table using a symbolic system operating on the example rows and auxiliary information to guide construction, wherein the symbolic system comprises a model that relies on row and column level consistency measures based on (1) semantic features including embedding similarity and (2) symbolic features including regexes and types; and
iteratively refining the constructed final table by identifying a worst scoring row as to the consistency measures and adjusting that worst scoring row until either the consistency scores are above a threshold or a maximum number of iterations is reached.
